(19) United States
(12) Patent Application Publication
(10) Pub. No.: US 2026/0054458 A1
(43) Pub. Date: Feb. 26, 2026

(54) STRUCTURE REPAIR USING FERROMAGNETIC INDUCTION HEATING AND THERMOPLASTIC ADHESIVE

(71) Applicant: Temper IP, LLC, Cedar Springs, MI (US)

(72) Inventors: Luke A. Martin, Wyoming, MI (US); William C. Dykstra, Rockford, MI (US)

(21) Appl. No.: 19/298,314

(22) Filed: Aug. 13, 2025

Related U.S. Application Data
(60) Provisional application No. 63/684,934, filed on Aug. 20, 2024.

(51) Int. Cl. B29C 73/10; B29C 73/34; B29L 31/30; B64F 5/40

(52) U.S. Cl. CPC B29C 73/10; B29C 73/34; B29L 2031/3076; B64F 5/40

(57) ABSTRACT

A method for repairing a damaged portion of an object includes providing a patch assembly that includes an outer portion, a sealing portion, and an attaching portion. The attaching portion includes a first layer including a thermally-reactive adhesive material and a second layer including ferromagnetic material. The patch assembly is positioned at the damaged portion so that an adhesive layer of the sealing portion engages the object at and around the damaged portion. Pressure is applied at the patch assembly, causing the outer portion and the attaching portion to flex and conform to the object, and heat is applied at the attaching portion by generating an electromagnetic field at the attaching portion to heat the ferromagnetic material, causing the thermally-reactive adhesive material to at least partially melt. The melted adhesive material engages the object outboard of the sealing portion and cures to bond the patch assembly to the object.

### CROSS REFERENCE TO RELATED APPLICATION

The present application claims the filing benefits of U.S. provisional application Ser. No. 63/684,934, filed Aug. 20, 2024, which is hereby incorporated herein by reference in its entirety.

### FIELD OF THE INVENTION

The present invention relates generally to a method and system for attaching a patch at a metal panel or composite panel, such as for an aircraft, vehicle or carrier.

### BACKGROUND OF THE INVENTION

Methods for patching holes are generally known in the aerospace industry. For example, repairs may be made quickly with aluminized tape or speed tape, but speed tape can only be used on small, superficial repairs. Formed and riveted doubler panels are suitable for structural repairs to aluminum structures and highly engineered scarf patches are suitable for structural repairs to composite structures, but take significantly more time and skill to complete.

### SUMMARY OF THE INVENTION

A patch assembly and a method for repairing a damaged portion of a vehicle, structure, tool or the like, with the patch assembly includes providing the patch assembly, which includes an outer portion, a sealing portion and an attaching portion between the outer portion and the sealing portion. The attaching portion includes a ferromagnetic material and an adhesive material. The patch assembly is positioned at a damaged portion of an aircraft so that the sealing portion engages the aircraft at and around the damaged portion and forms a seal between the patch assembly at the aircraft. Pressure and/or heat may be applied to the patch assembly to at least partially conform the patch assembly to the aircraft. With the patch assembly positioned at the damaged portion of the aircraft, pressure is applied to the patch assembly and an electromagnetic field is generated at the patch assembly. With the ferromagnetic material exposed to the electromagnetic field, the ferromagnetic material heats and the adhesive material melts. With the patch assembly positioned at the damaged portion of the aircraft, and with the ferromagnetic material generating heat, applying pressure at the patch assembly causes the outer portion and the attaching portion of the patch assembly to flex and conform to a shape of the aircraft. With the patch assembly positioned at the damaged portion of the aircraft, and with the attaching portion of the patch assembly flexed to conform to the shape of the aircraft, the adhesive material engages the aircraft outboard of the sealing portion, and the adhesive material cures to bond the patch assembly to the aircraft.

These and other objects, advantages, purposes and features of the present invention will become more apparent upon review of the following specification in conjunction with the drawings.

### BRIEF DESCRIPTION OF THE DRAWINGS

FIG. 1 is a perspective view of an aircraft with a damaged portion;

FIG. 2 is an exploded view of a patching assembly for repairing the damaged portion of the aircraft;

FIG. 3 is a perspective view of the patching assembly being positioned at the damaged portion of the aircraft;

FIG. 4 is an exploded view of the patching assembly being positioned at the damaged portion of the aircraft;

FIG. 5 is a perspective view of the patching assembly being positioned at the damaged portion of the aircraft, with a protective layer removed from a sealing portion for initially attaching the patching assembly to the aircraft;

FIG. 6 is a perspective view of the patching assembly attached at the aircraft via the sealing portion;

FIG. 7 is a perspective view of a heating blanket positioned over the patching assembly at the aircraft, with a resistance heating element of the heating blanket operating to heat the patching assembly;

FIG. 8 is a perspective view of the heating blanket positioned over the patching assembly at the aircraft, with an induction element of the heating blanket operating to heat a ferromagnetic susceptor of the patching assembly to activate an adhesive material of the patching assembly;

FIG. 9 is a perspective view of the patching assembly attached at the aircraft via the adhesive material;

FIG. 10 is a perspective view of the patching assembly removed from the aircraft;

FIG. 11A is a perspective view of an exterior side of a damaged thermoplastic composite structure;

FIG. 11B is a perspective view of an interior side of the damaged thermoplastic composite structure;

FIGS. 12A and 12B are perspective views of the damaged thermoplastic composite structure with portions of the thermoplastic composite structure removed to form attachment surfaces at the damaged regions;

FIG. 13 is an exploded view of the damaged thermoplastic composite structure, thermoplastic composite plugs configured to interface with the attachment surfaces and ferromagnetic heaters that are clamped together for repairing the thermoplastic composite structure;

FIG. 14 is a sectional view of the thermoplastic composite structure, plugs and ferromagnetic heaters clamped together;

FIGS. 15A and 15B are perspective view of the thermoplastic composite structure with the plugs attached at the attachment surfaces to repair the damaged regions;

FIG. 16 is an exploded view of the damaged thermoplastic composite structure, the thermoplastic composite plugs, ferromagnetic weld tape disposed between the plugs and the attachment surfaces of the thermoplastic composite structure and non-magnetic pressure plates that are clamped together for repairing the thermoplastic composite structure;

FIG. 17 is a sectional view of the thermoplastic composite structure, plugs, ferromagnetic weld tape and pressure plates clamped together;

FIGS. 18A and 18B are perspective view of the thermoplastic composite structure with the plugs attached at the attachment surfaces via the ferromagnetic weld tape to repair the damaged regions;

FIG. 19 is an exploded view of the thermoplastic composite structure, one thermoplastic composite plug and ferromagnetic weld tape disposed between the plug and the attachment surface of the thermoplastic composite structure;

FIG. 20 is a sectional view of the thermoplastic composite plug attached at the attachment surface of the thermoplastic composite structure via the ferromagnetic weld tape;

FIG. 21 is a perspective view of an induction heating blanket;

FIG. 22 is an exploded view of the thermoplastic composite structure, one thermoplastic composite plug, ferromagnetic weld tape disposed between the plug and the attachment surface of the thermoplastic composite structure and the induction heating blanket; and

FIG. 23 is a sectional view of the thermoplastic composite plug disposed at the attachment surface of the thermoplastic composite structure via the ferromagnetic weld tape and the induction heating blanket attached to the thermoplastic composite structure and extending over the plug.

### DESCRIPTION OF THE PREFERRED EMBODIMENTS

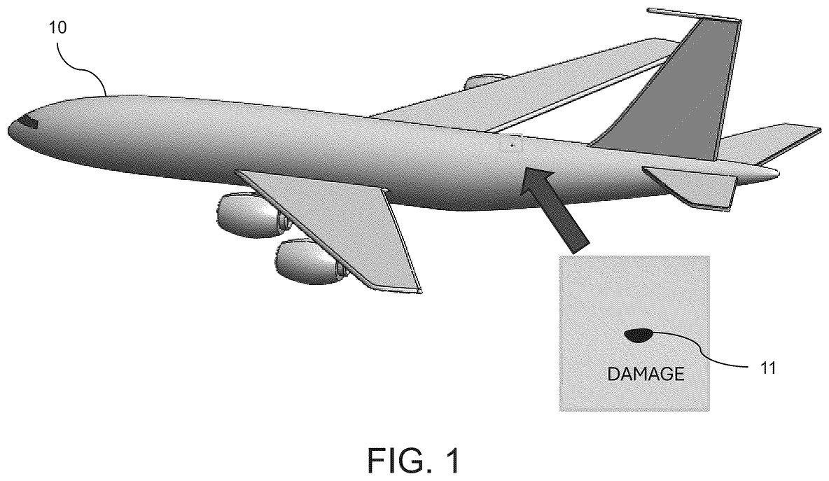

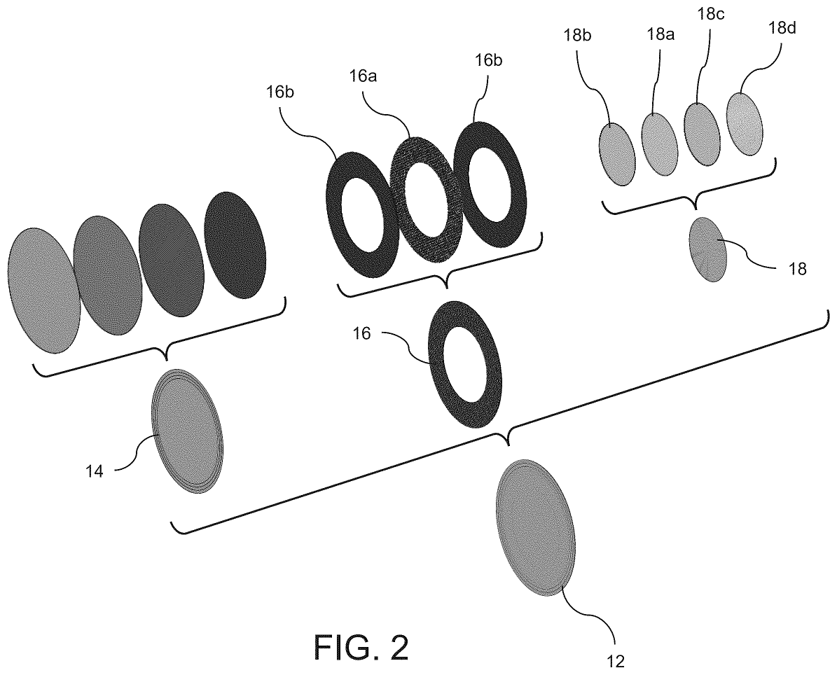

Referring now to the drawings and the illustrated embodiments depicted therein, a temporary repair system or patching assembly 12 for repairing a damaged portion 11 of an aircraft 10 includes a first layer or outer portion 14 that is disposed at the aircraft 10 and covers the damaged portion 11 and a second layer or ferromagnetic attaching portion 16 positioned between at least part of the outer portion 14 and the aircraft 10 for attaching the outer portion 14 to the aircraft 10 (FIGS. 1 and 2). The attaching portion 16 includes a layer of ferromagnetic material (i.e., a ferromagnetic layer 16a) with adhesive material 16b (e.g., a structural thermoplastic adhesive) infused with or imbedded with or otherwise disposed at the ferromagnetic layer 16a. The ferromagnetic layer 16a may include ferromagnetic material in the form of a foil, a sheet, a mesh, a powder, and the like. When the ferromagnetic layer 16a is exposed to a magnetic field, the ferromagnetic material of the layer 16a rapidly heats and melts the adhesive material 16b to attach the attaching portion 16 and the outer portion 14 to the aircraft 10 as the adhesive material 16b cools and/or cures. The attaching portion 16 may then be reheated by the ferromagnetic layer 16a for removing the patching assembly 12 from the aircraft 10.

As discussed further below, pressure may be applied to the patching assembly 12 before and/or during heating of the attaching portion 16 to cause the patching assembly 12 to generally conform to the outer surface of the aircraft 10 at or near the damaged portion 11. Pressure may be applied to the patch 12 using a vacuum and atmospheric pressure or using a pressure vessel such as an autoclave. In order to create the vacuum, the damaged portion 11 may first be covered to prevent air from leaking through the damaged portion 11. Thus, to seal the damaged portion 11 and prevent air from leaking into the vacuum area and causing a loss in pressure, a sealing layer or portion 18 of the patching assembly 12 may be attached to the aircraft 10 at or near or surrounding the damaged portion 11 and between the aircraft 10 and the outer portion 14 and/or part of the attaching portion 16 before applying the vacuum (FIG. 4). The sealing portion 18 may comprise part of the patching assembly 12 or be attached to the aircraft 10 prior to attaching the outer portion 14 and attaching portion 16.

The outer portion 14 of the patching assembly 12 may include one or more layers of flexible and/or semi-rigid material, such as aluminum or titanium sheets and/or layers of thermoplastic composite or fabric including fibers and resin. The layers of the outer portion 14 may be shaped and/or sized based on the damaged portion 11 of the aircraft 10. In the illustrated example of FIG. 2, the outer portion 14 includes rounded layers stacked together and having respective diameters of 10 inches, 9.5 inches, 9 inches, and 8.5 inches, where the layers are assembled and consolidated during the repair. Optionally, the outer portion 14 may be trimmed based on the size and/or shape of the damaged portion 11.

Further, the composition of the outer portion 14 may be adjusted based on the aircraft being repaired. For example, the thermoplastic composite of the outer portion 14 may correspond to a composite material of the aircraft 10, while aluminum structures may be repaired using a common aluminum-based patch assembly suitable for a variety of aluminum or titanium or other metallic structures. The layers of the outer portion 14 may comprise different materials or each layer may comprise the same material.

That is, the thermoplastic composite of the outer portion 14 may provide the structural component of the patch 12. The outer portion 14 may include a single ply of composite or multiple plies including various sizes to achieve a taper as the plies are stacked. The thermoplastic composite layer of the outer portion 14 may have a consolidation temperature of about 300 degrees Fahrenheit or less, such as for application to aluminum and thermoset structures. Optionally, the outer portion 14 may have a consolidation temperature of up to about 900 degrees Fahrenheit or more. Put another way, the composite may have a melting temperature or processing temperature between about 100 degrees Fahrenheit and 900 degrees Fahrenheit. When the composite is heated at or near or above its melting temperature, the layers or plies of composite material at least partially melt and may fuse together, and the composite material may at least partially melt and join the patch to the structure being repaired.

Additionally, the composition of the composite may include a thermoplastic resin with a fiber reinforcement. The fiber reinforcement may include carbon fiber, fiberglass, KEVLAR® or the like. The fiber reinforcements can be impregnated with the resin or woven together with the resin like down with intermingled fiber composites. Optionally, the thermoplastic resin may include a thermoset resin or a combination of thermoplastic and thermoset resins and the composite may include a thermoset composite or a thermoplastic composite.

The sealing portion 18 may be configured to be disposed over or cover the damaged portion 11 and maintain a position of the patching assembly 12 during heating of the attaching portion 16. As shown in FIG. 2, the sealing portion 18 is disposed at least partially inboard of the attaching portion 16 to engage the portion of the aircraft 10 surrounding the damaged portion 11 and the outer portion 14 when the patching assembly 12 is disposed at the aircraft 10. In other words, the thermoplastic adhesive and ferromagnetic material of the attaching portion 16, and the thermoplastic composite of the outer portion 14 extend beyond the perimeter of the sealing portion 18 so that the attaching portion 16 may directly engage and attach to the portion of the aircraft 10 surrounding the damaged portion 11 and the outer portion 14. For example, the attaching portion 16 may include an annular profile so that the sealing portion 18 engages the outer portion 14 through an opening of the attaching portion 16.

The sealing portion 18 may include one or more layers of adhesive material and one or more layers of structural or rigid or semi-rigid material, such as aluminum or stainless steel. In the illustrated example, the sealing portion 18 includes an inner layer or structural layer 18a of stainless steel sandwiched between a first adhesive layer 18b and a second adhesive layer 18c. The first adhesive layer 18b attaches the sealing portion 18 to the outer portion 14 and/or the attaching portion 16 and the second adhesive layer 18c attaches the patching assembly 12 to the aircraft 10. An outer layer or cover layer 18d may comprise a peel-off cover or layer that is removably disposed over the second adhesive layer 18c to protect the second adhesive layer 18c prior to being attached to the aircraft 10.

Optionally, the sealing portion 18 may include any non-magnetic tape with an adhesive that withstands the application temperature of the patching assembly 12. The sealing portion 18 may include aluminized tape, like speed tape, a stainless-steel film, or any non-magnetic material. Optionally, the sealing tape includes a metalized tape, a reinforced composite tape, a self-sealing tape and the like. Additionally, the sealing portion 18 may be incorporated into the patching assembly 12 as a pre-packaged solution for common size repairs. Optionally, the sealing portion 18, the attaching portion 16 having the ferromagnetic material with imbedded thermoplastic adhesive, and the thermoplastic composite outer portion 14 may be supplied individually so repair technicians may cut out the shapes required, such as using a scissors or shear or other suitable cutting instrument.

The adhesive material 16b of the attaching portion 16 may have a sufficiently long shelf life such that the adhesive material 16b is stable at room temperature. That is, the adhesive material 16b may not become tacky or adhere to the aircraft 10 until heated. Additionally, once the patching assembly 12 is applied, it may be re-heated to re-soften the thermoplastic adhesive material 16b so the patching assembly 12 may be easily removed. The thermoplastic adhesive material 16b may have a melting temperature between about 100 degrees Fahrenheit and about 900 degrees Fahrenheit. For example, the adhesive material 16b may process or begin melting when heated to about 275 degrees Fahrenheit or more. Thus, before being heated, the attaching portion 16 may resist adhering to the aircraft 10 or other surfaces so that the patching assembly 12 may be stored in a variety of environments. After being installed at the aircraft 10, the adhesive material 16b may resist removal of the patch assembly 12 from the aircraft until the adhesive material 16b is reheated at or near its processing temperature (e.g., 275 degrees Fahrenheit or more). The thermoplastic adhesive material 16b may include a liquid, a pre-mixed paste, two-part mixture, thin film, or any other suitable adhesive. Further, the thermoplastic adhesive may comprise a thermoset adhesive, a thermoplastic, and/or a combination of thermoset and thermoplastic.

The adhesive material 16b may be embedded into the ferromagnetic material of the ferromagnetic layer 16a of the attaching portion 16, which includes a ferromagnetic material having a Curie temperature at or near or above the processing temperature of the adhesive material 16b. The adhesive material 16b may be imbedded in the ferromagnetic material in any suitable shape, such as an annular shape, a circular shape, an irregular shape and the like. Thus, when the patching assembly 12 is exposed to a magnetic field, the ferromagnetic layer 16a may rapidly heat to a temperature at or near the Curie temperature of the ferromagnetic material. This quickly heats the adhesive material 16b to its processing temperature and causes the patching assembly 12 to begin bonding to the aircraft 10. Moreover, the ferromagnetic properties of the layer 16a may cause it to stop heating at or near its Curie temperature.

In other words, given the proper conditions, an electrically conductive ferromagnetic substance will experience heating when subject to a sufficiently high-frequency electromagnetic field. Ferromagnetic materials such as iron, nickel, cobalt, and their many alloys, have a composition-specific temperature, the Curie temperature, above which their relative magnetic permeability (μᵣ) decreases until it is approximately equal to that of ordinary air or a vacuum, and electromagnetically induced ferromagnetic heating ceases to occur. The electromagnetic heating process is capable of extremely efficient and rapid energy transfer, and electromagnetic heating has been demonstrated to produce temperature rises of hundreds of kelvins very rapidly, such as, for example, in less than a second.

Electromagnetic fields can pass through many electrical insulators, such as air, glass, plastics, and non-metallic ceramics, without heating them, and if conductive materials, such as ferrous alloys, copper, aluminum, etc., are located in the electromagnetic field, a field of the appropriate frequency range will heat only the conductive materials.

The ferromagnetic layer 16a may include a solid metallic foil, a sheet, a mesh, a powder, and the like. The metal alloy used for the ferromagnetic material may be selected such that its magnetic permeability decreases as its temperature increases. The ferromagnetic material will rapidly heat via induction while its magnetic permeability is high and becomes increasingly difficult to heat as the temperature increases to a temperature at or near its Curie temperature and its magnetic permeability decreases. This helps to control the temperature of the ferromagnetic material to ensure it does not over-heat and cause heat damage to the thermoplastic adhesive material 16b, thermoplastic composite outer portion 14, the aircraft 10 and the like. The ferromagnetic layer 16a may include a hole cut out of the center to prevent direct heating of the sealing portion 18 or the ferromagnetic susceptor 16a may extend over and along the sealing portion 18 to provide uniform heat over the patching assembly 12.

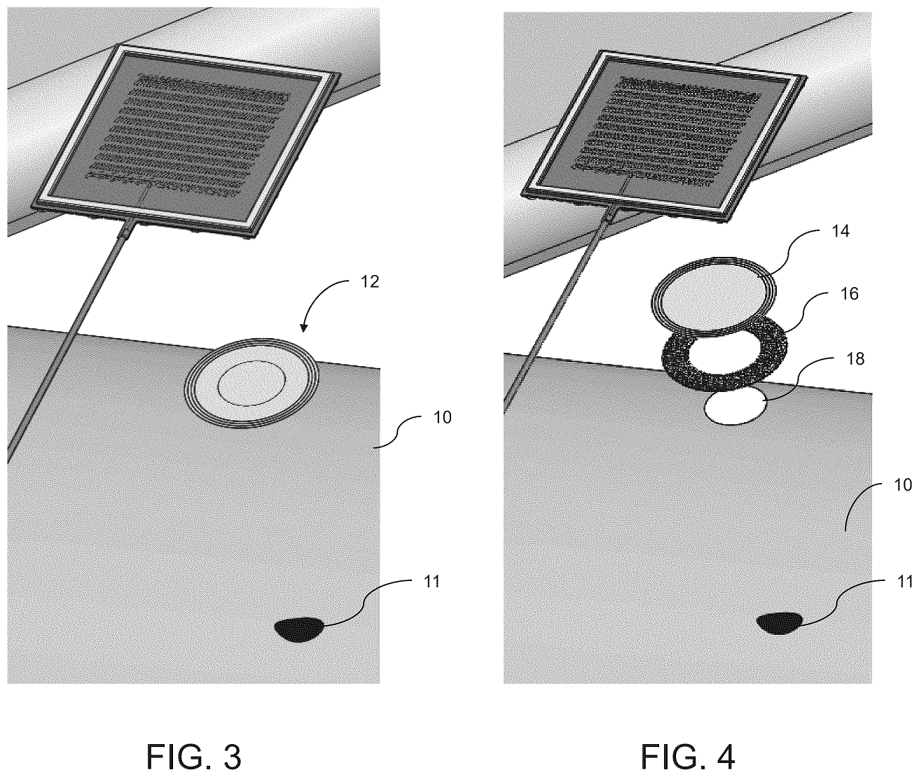

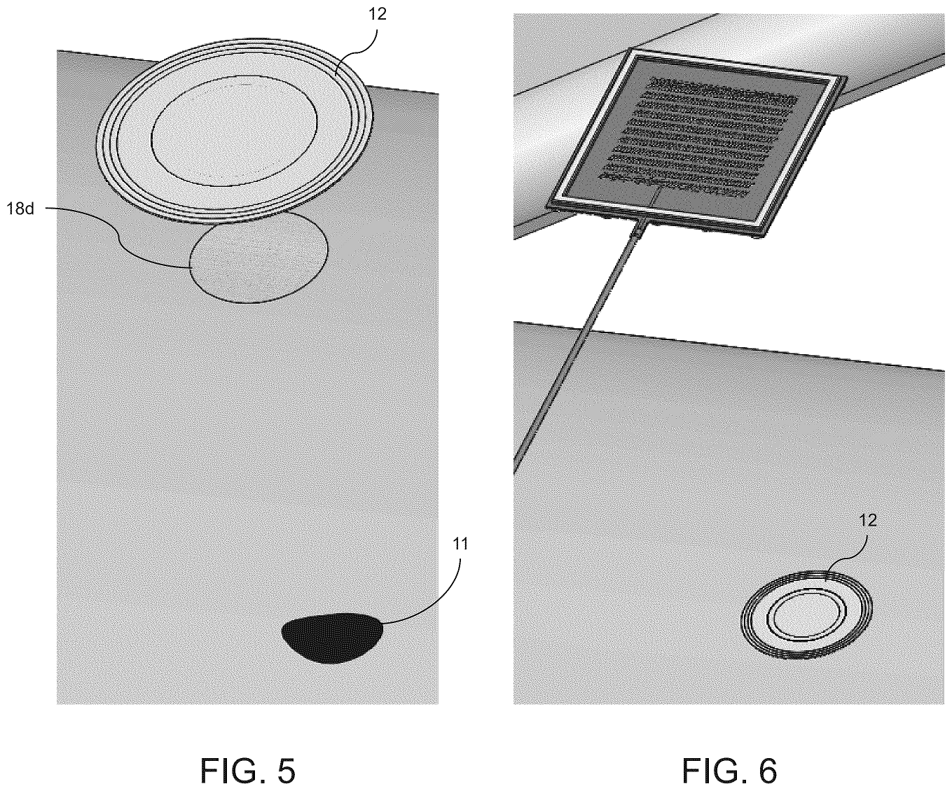

Referring to FIGS. 3-9, the patching assembly 12 may be applied to the aircraft 10 as a consolidated unit (FIG. 3), or each layer of the patching assembly 12 may be applied in succession (FIG. 4). After the protective layer or backing 18d is removed from the sealing portion 18 (FIG. 5), the patching assembly 12 may be placed over the damaged portion 11 (FIG. 6). With the sealing portion 18 attached to the aircraft 10 at or surrounding the damaged portion 11, the sealing portion 18 may generally conform to the surface of the aircraft 10 and seal the damaged portion 11. That is, the sealing portion 18 may form an airtight seal at the surface of the aircraft 10 surrounding the damaged portion 11.

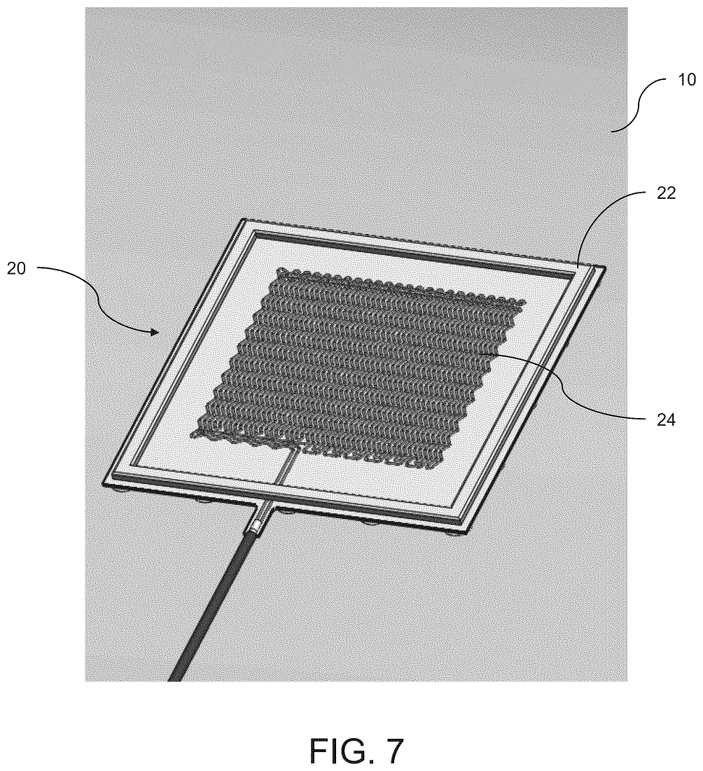

With the sealing portion 18 attaching the patching assembly 12 at the aircraft 10, a heating blanket or induction blanket or heating device or vacuum membrane 20 may be positioned at the aircraft 10 and over the patching assembly 12 (FIG. 7). The heating blanket 20 may include a perimeter seal or suction element 22 that attaches the heating blanket 20 to the aircraft 10 around the patching assembly 12 and the damaged portion 11 and forms a seal between the heating blanket 20 and the aircraft 10. The heating blanket 20 may include or be connected to a vacuum source for applying the vacuum at the patching assembly 12.

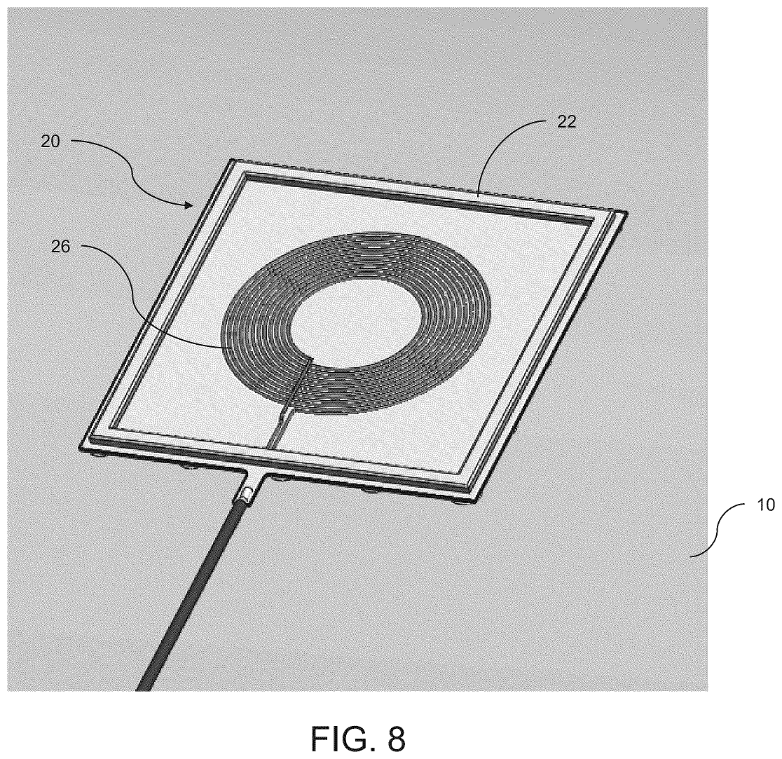

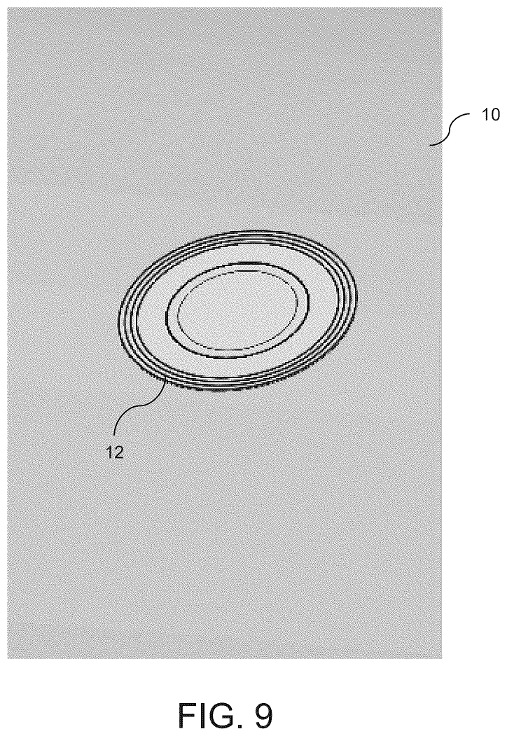

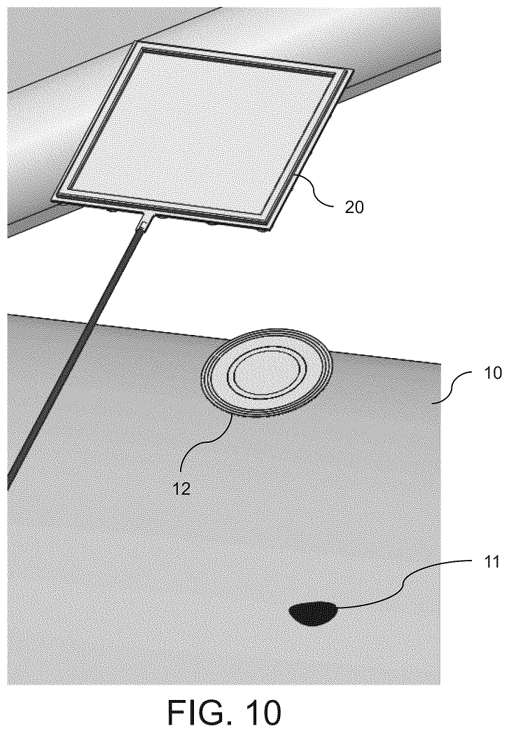

During a first heating step, the vacuum source may be operated to apply the vacuum to the patching assembly 12 and heat may be applied with the flexible heating blanket 20. For example, a resistance heating element 24 of the heating blanket 20 may be operated to heat the patching assembly 12 (FIG. 7). The first heating step may cause the thermoplastic composite outer portion 14 of the patching assembly 12 to soften and at least partially conform to the outer surface of the aircraft 10 surrounding the damaged portion 11. During a second heating step, the resistive heating element 24 may be turned off and an inductive coil 26 of the heating blanket 20 may be operated to generate the magnetic field at the patching assembly 12 (FIG. 8). The induction field may pass through the vacuum membrane and thermoplastic composite outer portion 14 and energize the ferromagnetic material of the ferromagnetic layer 16a. Thus, the second heating step may cause the ferromagnetic layer 16a of the attaching portion 16 to heat and soften the adhesive material 16b and thus weld the patching assembly 12 to the aircraft 10. Moreover, heating the ferromagnetic layer 16a may consolidate the thermoplastic composite layers of the outer portion 14. Following the second heating step, the induction field may be turned off and/or the heating blanket 20 may be removed from the aircraft 10 and the adhesive material 16b may set or cure to secure the patching assembly 12 at the aircraft 10 (FIG. 9). The patching assembly 12 may be passively cooled (e.g., exposed to ambient air to cure) or actively cooled (e.g., the patching assembly 12 may be exposed to cooling airflow or fluid coolant).

Thus, the combination of vacuum and heat may be used to shape the patching assembly 12 to the damaged structure and set the patch. By pulling the vacuum, atmospheric pressure contours the patch 12 to the damaged area and applies pressure to the attaching portion 16. The heat softens the thermoplastic adhesive material 16b, which sets it to the aircraft 10, and also softens the thermoplastic composite of the outer portion 14 of the patch 12. Softening the thermoplastic composite outer portion 14 allows it to become formable and contour to the shape of the aircraft 10. Additional or continued heating of the thermoplastic composite outer portion 14, while under pressure from the vacuum, may consolidate the composite plies into a unified structure. Upon cooling, which may be done actively or passively, the thermoplastic materials may be set. That is, the composite plies become rigid and the adhesive material 16b sets.

In some examples, the heat is applied to the patch 12 using the flexible induction blanket 20. The induction blanket 20 may be placed underneath a vacuum bag. In the illustrated example, the induction blanket 20 incorporates the vacuum seal 22 into its perimeter to provide an all-in-one, reusable, vacuum bag induction blanket. The induction blanket 20 may also incorporate a single induction coil or an array of induction coils. For example, the induction coils may operate at different frequencies to target different heating profiles and temperatures, or couple into different ferromagnetic materials. In other words, the heating blanket 20 may include a film sealed to the aircraft 10 with, for example, a tape or a putty, and with the induction coil 26 under the film. Additionally, the different ferromagnetic materials may be incorporated directly into the induction blanket and/or the heating blanket 20 may further include the resistive heating elements 24.

Optionally, operation of the heating blanket 20 to set the patching assembly 12 at the aircraft 10 may be an automated process at least partially controlled by a control unit or module in communication with the heating blanket 20. The control unit may include electronic circuitry and associated software for controlling operation of the heating blanket 20, and the control unit may be accommodated at a user device (e.g., a computer or mobile device) electrically connected to the heating blanket 20 (e.g., via wired or wireless communication) and/or integrated with the heating blanket 20. For example, with the patching assembly 12 initially disposed at the damaged portion 11 of the aircraft 10, the heating blanket 20 may be placed over the patching assembly 12 at the aircraft 10 and the perimeter seal 22 may secure the heating blanket 20 at the aircraft 10. With the heating blanket 20 secured at the aircraft 10, the control unit may operate the vacuum source to apply the vacuum to the patching assembly 12 between the heating blanket 20 and the aircraft 10, and the control unit may operate the resistance heating element 24 to heat the patching assembly 12. The resistance heating element 24 may be operated for a threshold period of time to soften the thermoplastic composite exterior portion 14 and conform the patching assembly 12 to the aircraft 10. Optionally, one or more sensors such as thermocouples may be disposed at or near the patching assembly 12, such as integrated with the heating blanket 20, and the heating element 24 may be operated so that the temperature of the patching assembly 12 reaches at least a threshold temperature. After the patching assembly 12 is conformed to the aircraft 10, the induction element 26 may be operated to generate the magnetic field and heat the ferromagnetic layer 16a. The induction element 26 may be operated for a threshold period of time and/or until the patching assembly 12 reaches at least a threshold temperature. The control unit may release the vacuum source and/or the perimeter seal 22 after heating so that the heating blanket 20 may be removed from the aircraft 10 to allow the patching assembly 12 to cure.

To remove the patching assembly 12 from the aircraft 10, the heating blanket 20 may be positioned at the aircraft 10 and over the patching assembly 12 and the induction element 26 may be operated to reheat the ferromagnetic layer 16a. Heating the ferromagnetic layer 16a heats and softens the adhesive material 16b of the attaching portion 16 and loosens the patch assembly 12 from the aircraft 10. With the adhesive material 16b heated and loosened, the patching assembly 12 may be removed from the aircraft 10 (FIG. 10).

Thus, the patching assembly 12 and method for application may bridge a gap between superficial and structural repairs as the ferromagnetic properties of the patching assembly 12 allow for relatively quick and robust repairs (e.g., the patch may be installed in ten minutes or less) that may be easily reversed or removed for future permanent repairs to the aircraft 10. The thermoplastic composite of the outer portion 14 gives the patch the rigidity needed to withstand aerodynamic pressures while transferring the required loads through the patch. Although described herein as being used to repair damaged portions of aircraft (such as holes, tears, and dents formed in the fuselage, wings and rotor blades of airplanes, helicopters, spacecraft and drones), aspects of the patching assembly 12 may be suitable for use with other vehicles, such as ground vehicles, motor vehicles, railed vehicles, amphibious vehicles and ships, and structures, such as buildings, tools, furniture and the like. The patching assembly 12 may be suitable for superficial and structural repairs of components formed from aluminum, titanium, thermoplastic composite materials, and the like.

Further, thermoplastic composites are being more frequently incorporated into vehicle bodies, such as aerospace structures. This is largely driven by the ability to rapidly manufacture with thermoplastic composites as the processing time is not dictated by the chemical reaction of the resin curing. However, thermoplastic composites may be challenging to repair.

Thermoset composites may be repaired with thermoset composites. This is possible because the chemical reaction that causes a thermoset to cure cannot be reversed. Therefore, the damaged area can be patched without undoing the cure of the adjacent thermoset materials. Thermoplastics, however, become soft and can be re-processed when heated, even after the first full consolidation cycle. That is, it may be challenging to repair thermoplastic composite with the same parent materials without using complex tooling or processing to prevent the heat from deforming the surrounding composite while still reaching the required process temperature to make the repair.

In some examples, a damaged structure formed from a thermoplastic composite or thermoset composite may be repaired using a plug or patch formed from the same or similar thermoplastic composite material or thermoset composite material. The plug is attached to the damaged structure by selectively applying heat to the damaged portion of the structure and the plug, while under pressure, to cause the resin of the thermoplastic material at the structure and the plug to melt and fuse together. The plug and structure may be heated using a ferromagnetic heating element to avoid over processing and deforming portions of the structure other than the damaged portion.

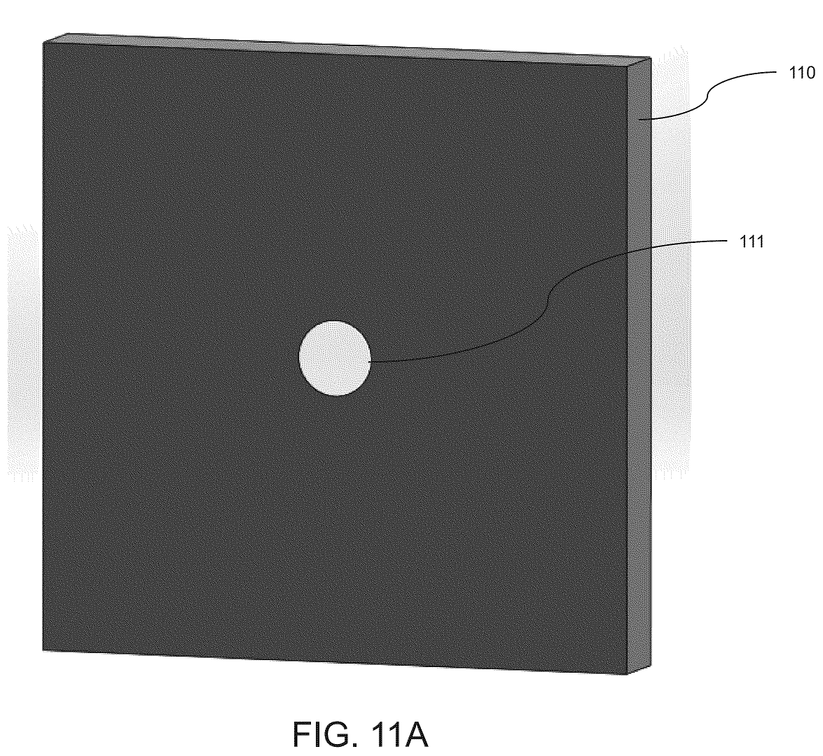

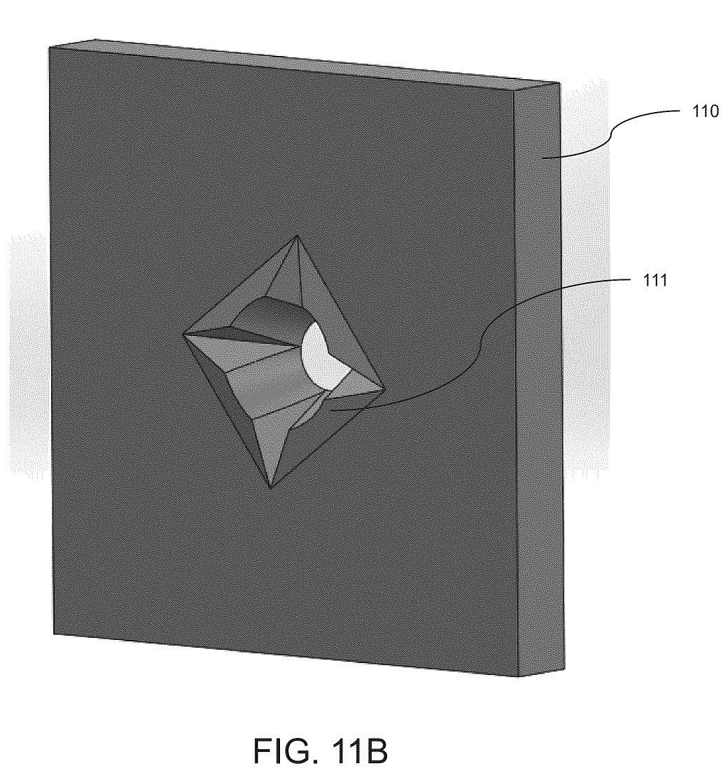

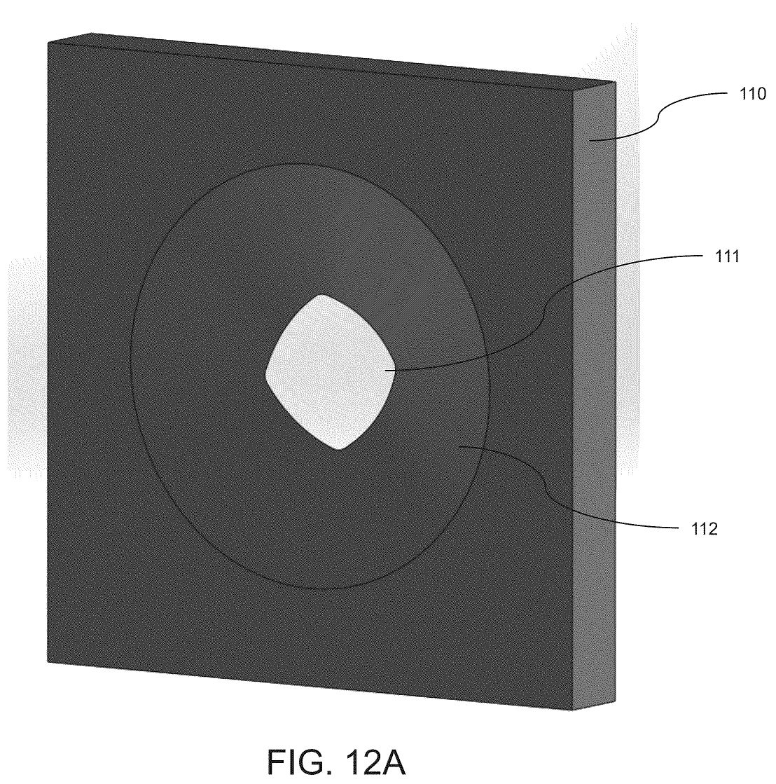

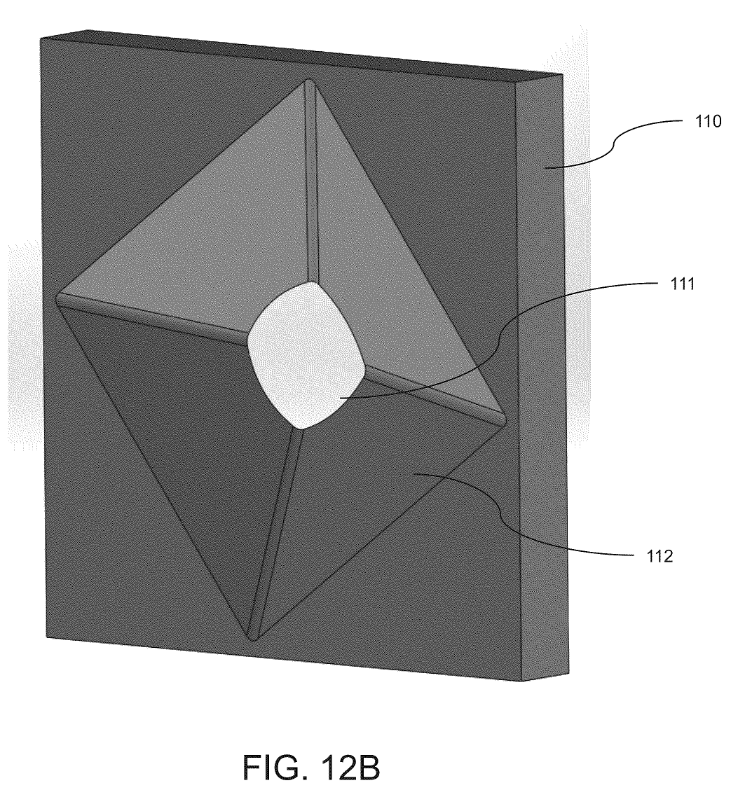

For example, and referring to FIGS. 11A-15B, a thermoplastic composite structure 110, such as the body of an aircraft or motor vehicle or boat, may include a damaged region or portion 111. The damaged region 111 may be caused by a high velocity impact (e.g., a projectile impacting the structure). To repair the thermoplastic composite structure 110, a user may remove damaged thermoplastic composite material from the damaged region 111 to form an attachment surface 112 at or surrounding the damaged region 111 (FIGS. 12A and 12B). For example, the user may use a hand-held tool or device like a CNC router to remove the thermoplastic composite material. In the illustrated example, respective attachment surfaces 112 are formed at both an exterior side or surface or entry side or surface of the structure 110 (FIG. 12A) and an interior side or surface or exit side or surface of the structure 110 (FIG. 12B). Optionally, the repair may be made only at one of the interior surface and the exterior surface. The attachment surface 112 may be shaped or contoured (e.g., with sloped or conical surfaces or with angled or faceted surfaces) to receive a correspondingly shaped or contoured plug or patch 114.

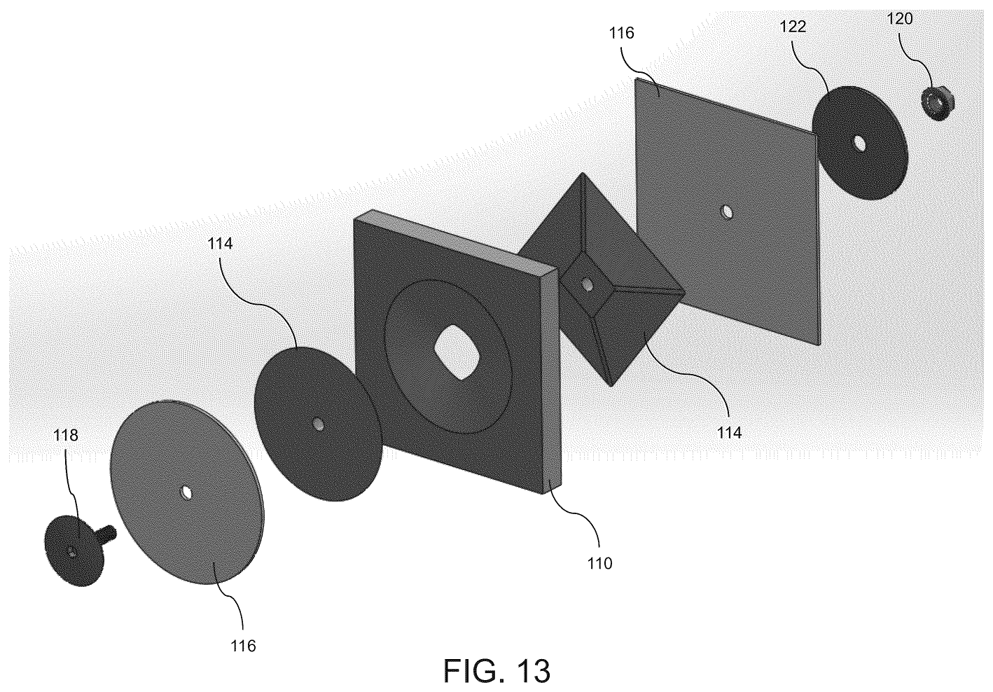

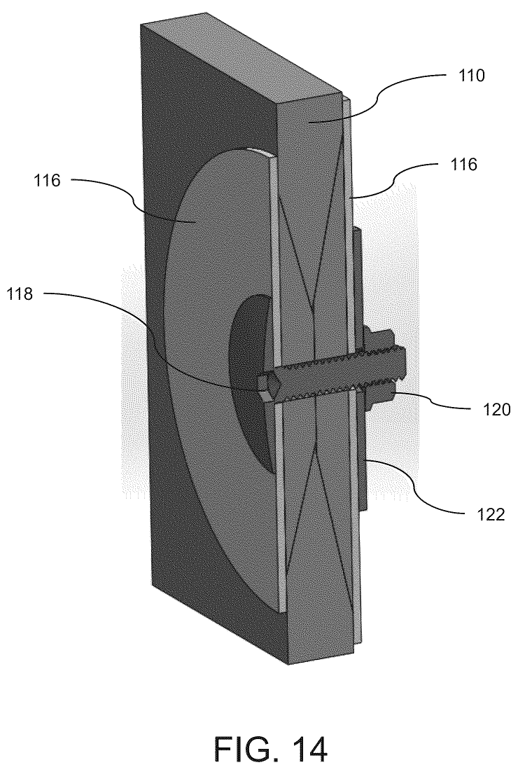

As shown in FIGS. 13 and 14, each plug 114 is shaped or contoured to at least partially fill the recess defined by the attachment surface 112 at the respective interior and exterior sides of the structure 110. The plug 114 may be formed from the same or similar thermoplastic composite material as the structure 110. Further, the plug 114 and/or machined attachment surface 112 may be shaped or contoured based on the damage caused to the structure 110. For example, rounded or circular plugs may be used to repair rounded or circular damage (e.g., holes caused by projectiles) while square or rectangular or faceted plugs may be used to repair elongated damage like rips or tears. The plug 114 may be shaped or contoured based on the application, or plugs 114 may be formed in common shapes and sizes for universal application.

With the plug 114 disposed in the recess at the structure 110 and engaging the attachment surface 112, a heating element or pad 116 such as a ferromagnetic heater is positioned at or over the plug 114 and a portion of the structure 110. In the illustrated example of FIGS. 13 and 14, respective heating elements 116 are positioned at the opposing sides of the structure 110 to heat both plugs 114. The shape or configuration of the heating element 116 may correspond to the shape of the plug 114 to deliver targeted heating and avoid applying heat to portions of the structure 110 spaced from the attachment surface 112.

The ferromagnetic heater includes ferromagnetic material that, when exposed to a magnetic field and energized, heats or generates heat. Ferromagnetic heating may be used to apply quick and targeted heating at the plug 114 and the structure 110 so that the respective attachment surfaces are heated and meld together without impacting the structural integrity of the core of the plug 114 and other portions of the structure 110. That is, the plug 114 may remain relatively rigid during the heating process while the portion of the plug 114 engaging the attachment surface 112 and the attachment surface 112 are heated and joined together. Moreover, the ferromagnetic heater may be energized by a magnetic field and thus operated in difficult to reach areas of the structure. That is, the magnetic field may be generated by a source or tool (e.g., an induction coil) disposed near the ferromagnetic heating element 116 and does not need to be engaged by the tool.

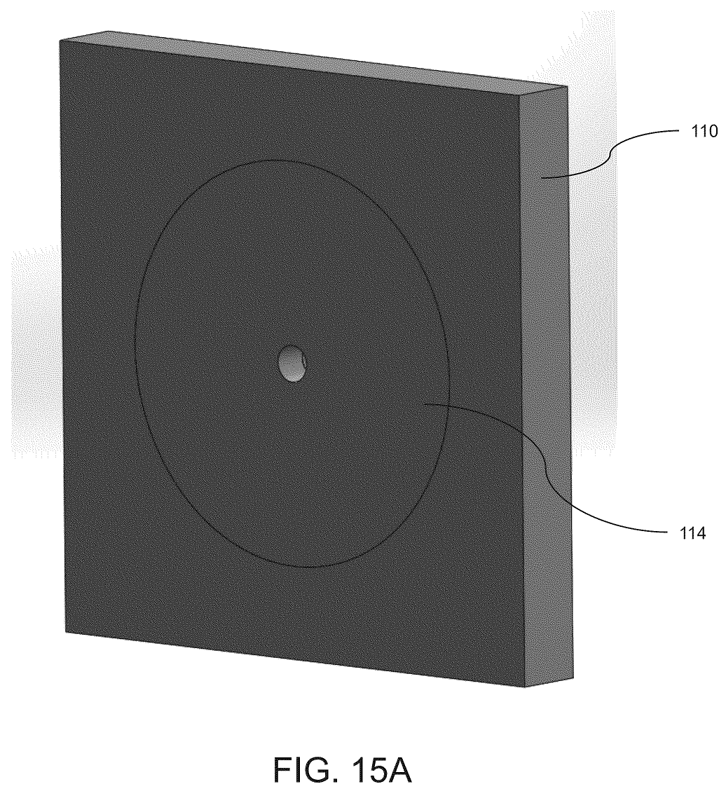

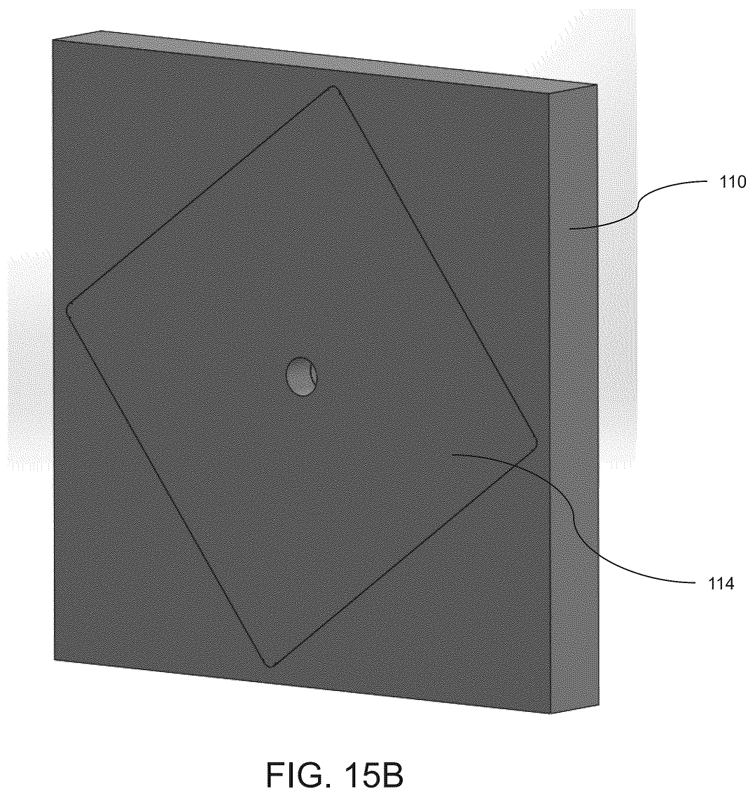

A pressure bolt 118 may extend through the heating elements 116, the plugs 114, and the structure 110 to be received by a threaded nut 120 and/or a washer 122 or biasing element (e.g., a Belleville spring). Thus, the bolt 118 (or other suitable fastener) may be tightened to the nut 120 (or other suitable receiver) to apply a clamping force and encourage joining of the plugs 114 to the structure 110 during heating. Following heating, with the plugs 114 at least partially joined to the structure 110, the bolt 118 may be unfastened to remove the heating elements 116, bolt 118, nut 120, and washer 122. The outer surface of the joined plugs 114 may be flush with the surfaces of the structure 110 (FIGS. 15A and 15B).

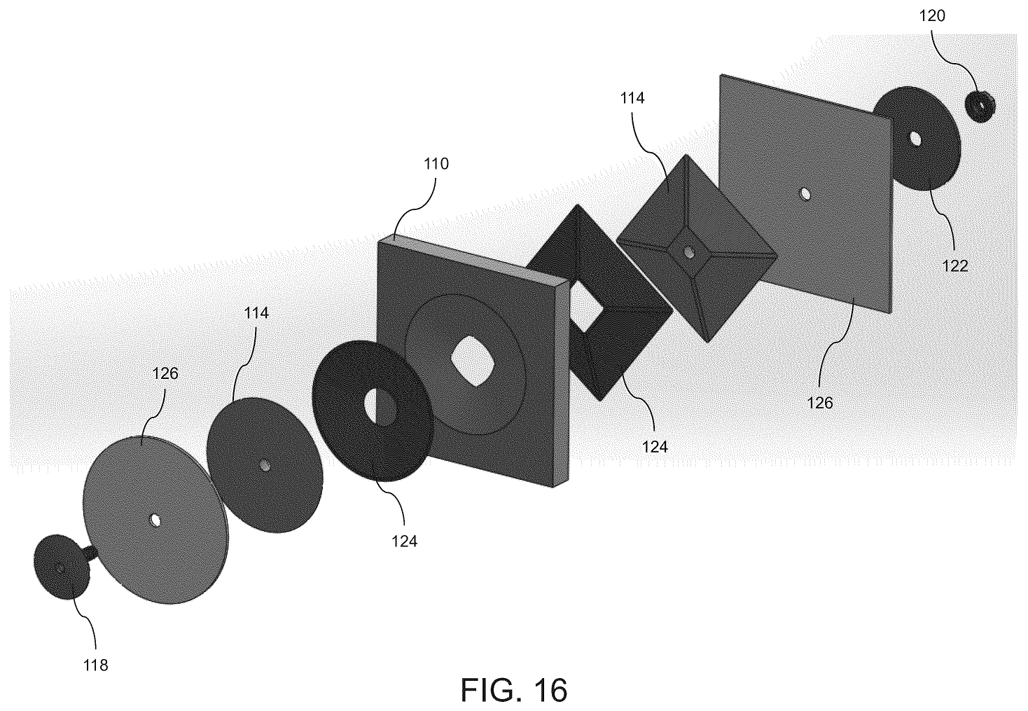

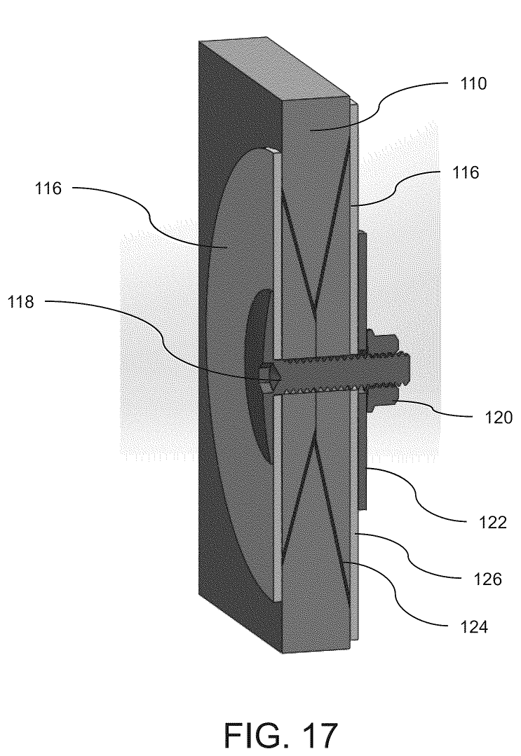

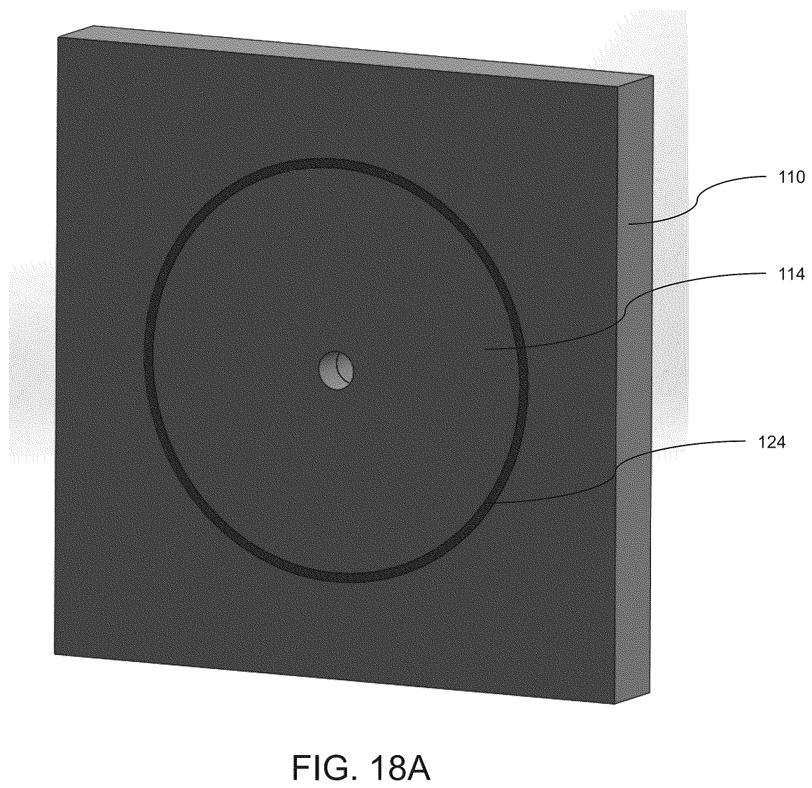

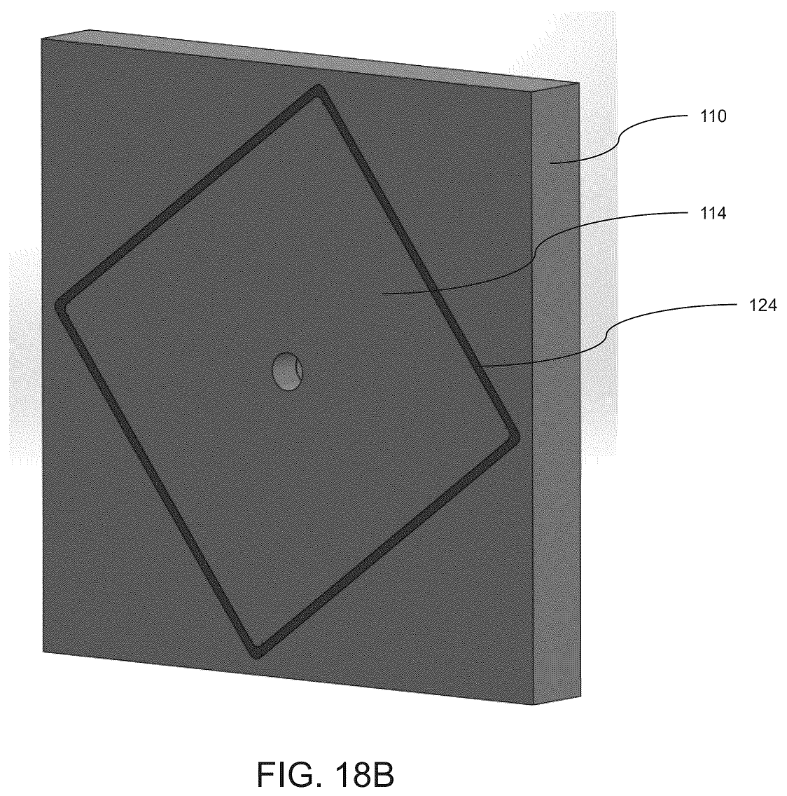

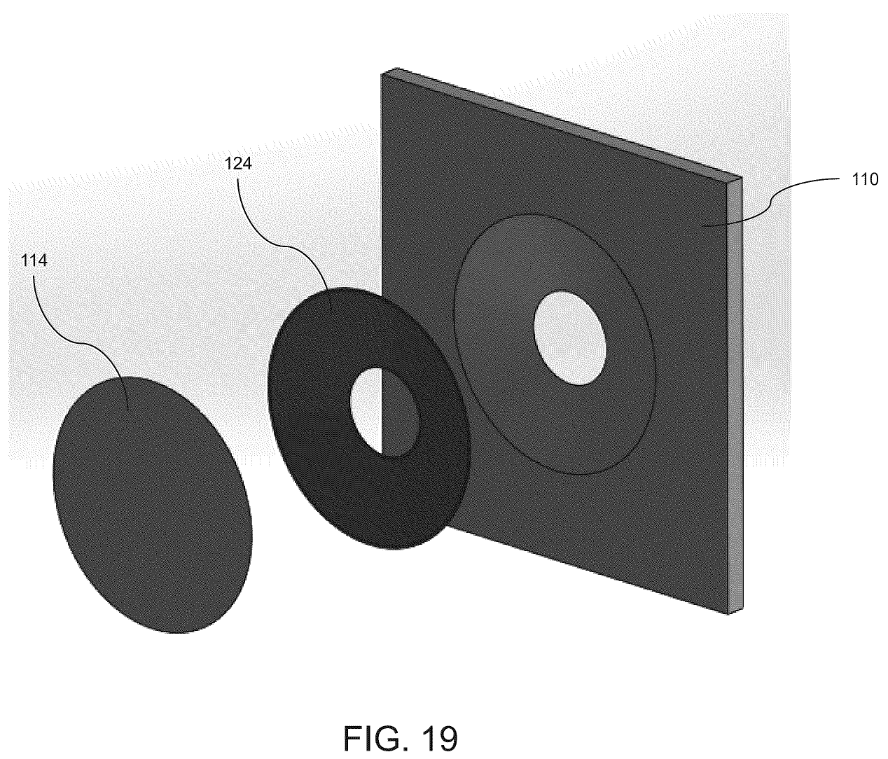

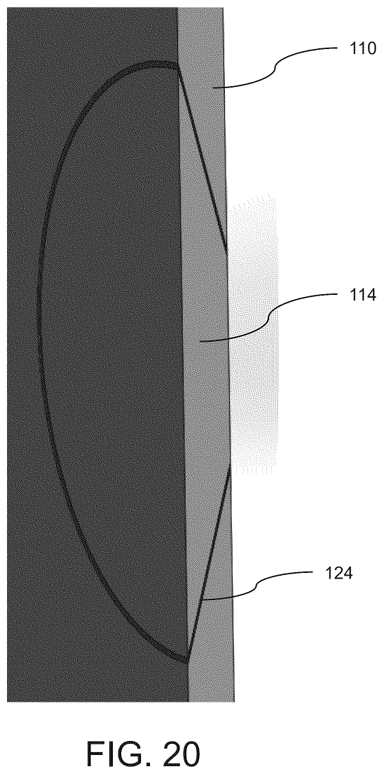

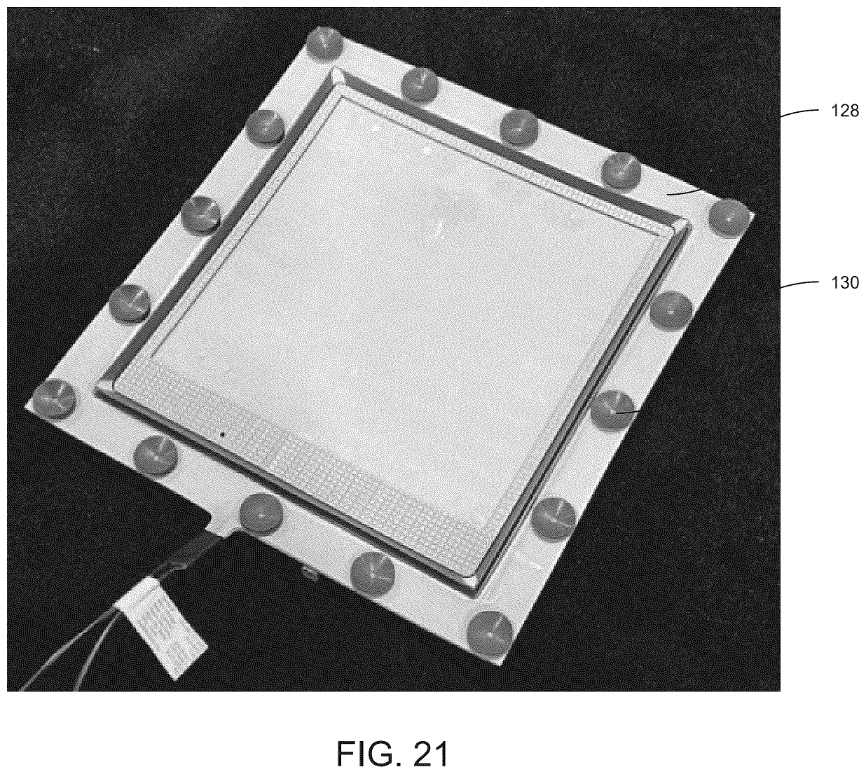

As shown in FIGS. 16-20, a layer of thermoplastic resin with imbedded ferromagnetic material, such as a ferromagnetic weld tape 124, may be positioned between the plug 114 and the attachment surface 112. Thus, when the magnetic field is generated at the structure 110, the ferromagnetic weld tape 124 heats the resin and/or the plug 114 and/or structure 110 to join the plug 114 and the weld tape 124 to the structure 110. Put another way, with the ferromagnetic weld tape 124 disposed between the plug 114 and the attachment surface 112, and responsive to exposure to the magnetic field, ferromagnetic material of the weld tape 124 heats and the resin of the ferromagnetic weld tape 124 may melt and join the plug 114 to the attachment surface 112. Non-magnetic pressure plates 126 may be disposed between the pressure bolt 118 and one plug 114 and between the biasing element 122 and the other plug 114 to distribute pressure along the plugs 114 during heating. Thus, after heating, the plug 114 is joined to the structure 110 with the ferromagnetic weld tape 124 disposed between the plug 114 and the attachment surface 112. Because the ferromagnetic material of the weld tape 124 remains between the plug 114 and the attachment surface 112, the plug 114 may be removed from the structure 110 by reenergizing the ferromagnetic material.

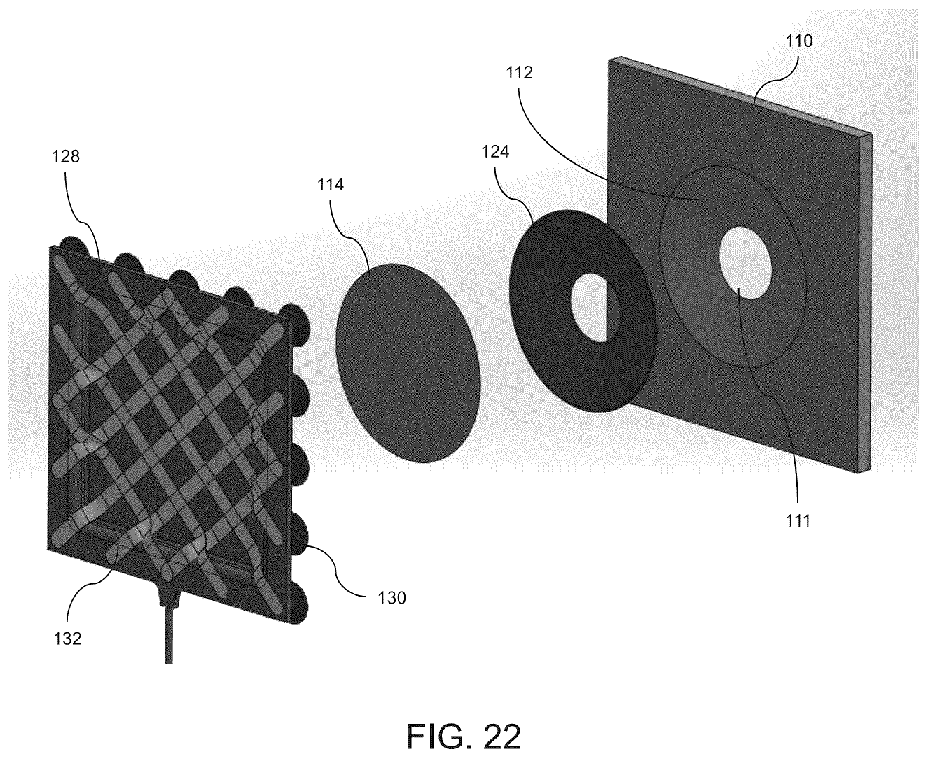

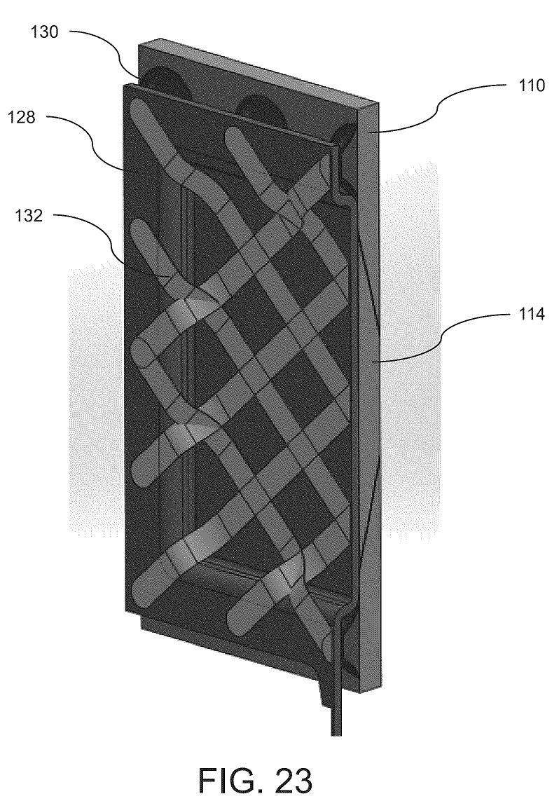

Optionally, a vacuum source may apply pressure between the plug 114 and the structure 110 during heating. For example, and referring to FIGS. 21-23, an induction heating blanket 128 having one or more suction devices 130, such as a perimeter seal and/or suction cups disposed about a perimeter of the heating blanket 128, may be disposed at the structure 110 and extending over the plug 114. With the plug 114 disposed at the damaged portion 111 and the ferromagnetic weld tape 124 disposed between the plug 114 and the attachment surface 112, the heating blanket 128 may be attached to the structure 110 and operated to form a vacuum between the heating blanket 128 and the structure 110. This vacuum applies pressure to urge the plug 114 toward engagement with the weld tape 124 and the attachment surface 112. Optionally, the heating blanket 128 may include one or more biasing elements 132, such as leaf springs, that urge the heating blanket 128 and/or suction devices 130 into engagement with the structure 110 to attach the heating blanket 128 at the structure 110 at and surrounding the plug 114.

With the heating blanket 128 attached to the structure 110, one or more induction elements of the heating blanket 128 are electrically energized to generate a magnetic field at the plug 114 and weld tape 124. Responsive to the magnetic field, the ferromagnetic weld tape 124 heats the plug 114 and attachment surface 112 and/or melts the resin of the weld tape 124 to join the plug 114 to the attachment surface 112. Optionally, the heating blanket may include one or more resistance heating elements to apply heat at the plug and structure, such as to heat outer portions of the plug 114 and structure 110 to close an outer seam between the plug 114 and structure 110.

Thus, the thermoplastic composite plug 114 with applied ferromagnetic heating may be used to repair thermoplastic composite parts by removing portions of the damaged composite, providing and/or forming the plug 114 to fill the removed area, and selectively applying heat to the plug 114 while under pressure. Devices, such as hand-held CNC routers, may be equipped with diamond cutters for removing portions of the damaged composite and suction cup devices may be used for positioning the removal devices. These devices may machine away the damaged composite and leave a well-defined hole with a known geometry. The plug 114 may be made using the same thermoplastic composite material as the structure 110 being repaired. For commonly damaged areas, plugs may be manufactured ahead of time and stored or manufactured to specific geometries. Selective application of heat while under pressure may be highly situational and geometry dependent. The thermoplastic plug 114 and structure 110 fuse together when the resin that make up both components is melted and fused together.

Plugs may be formed in any shape or size determined at least in part by the shape of the parent structure and type of damage that the parent structure has incurred. For example, in military applications, bullet holes may best be repaired with circular plugs. Further, a commercial aircraft damaged by a fuel truck may best be repaired with a square or rectangular shaped plug.

The heat is conducted from the ferromagnetic heater to melt the thermoplastic resin when the ferromagnetic heater is energized with the magnetic field. This allows the ferromagnetic heater to be placed anywhere, including inside the composite, as long as the magnetic field can reach it. For example, multiple ferromagnetic heaters can be used and placed on either side of the parent structure. This would generate heat on both sides of the parent structure and conduct through the thickness so that the centerline of the parent structure/plug would be the last area to reach the processing temperature. This ensures the centerline stays rigid and stiff for as long as possible so the thermoplastic composite may maintain its structure.

To accomplish the heating, an induction coil may be placed on both sides of the parent structure or placed on only one side. To apply the pressure, the bolt or fastener may be placed through the center of the plugs to act as a clamping force. This bolt or fastener may be removed after heating or remain a part of the repair.

Optionally, the heating may be generated by placing the ferromagnetic heater at the interface between the plug and parent structure, such as using the ferromagnetic weld tape. The weld tape is produced by imbedding ferromagnetic wires in thermoplastic resin. The ferromagnetic wires, which are approximately the diameter of a tow of composite fibers, generate the heat and the thermoplastic resin may be the same or similar to the resin as that used in the parent structure and plug. The magnetic field rapidly heats the ferromagnetic wires and melts the resin in the tape, and at the adjacent faces of the plug, and parent structure. This allows the heating, melting, and fusing to occur without fully heating the thickness of the plug or parent structure.

The magnetic field may be generated from an induction source, such as a coil, like a rigid coil or a more flexible Litz wire. For example, the induction blanket may include a flexible Litz wire that is embedded into a high temperature silicone rubber. This allows the coil to conform to the shape of the parent structure. Pressure may be applied to the plug through the induction blanket. For example, the pressure may be applied through an exterior network of suction cups and leaf springs incorporated into the induction blanket. Optionally, a separate framework may be attached to the parent structure, through suction cups, vacuum pressure, magnetics and the like, and pressure can be applied with a screw, spring, pneumatic bladder, or other mechanism. Put another way, the induction element may include a flexible coil, a rigid coil and the like. With the blanket attached to the structure, the coil is positioned using at least one of a suction cup, a magnetic fastener, a temporary fastener, an adhesive, a tape, and the like.

The heating blanket and patching assembly and ferromagnetic heating elements may utilize aspects of the heating blankets and systems described in U.S. Pat. Nos. 11,338,344; 10,981,209; 10,307,810; 9,656,317 and/or 9,174,263, and/or U.S. Pub. Nos. US-2023-0084714 and/or US-2024-014999 and/or International Publication No. WO-2022-213078, which are hereby incorporated herein by reference in their entireties.

Changes and modifications to the specifically described embodiments may be carried out without departing from the principles of the present invention, which is intended to be limited only by the scope of the appended claims as interpreted according to the principles of patent law including the doctrine of equivalents.

1. A method for repairing a damaged portion of an object, the method comprising:
providing a patch assembly comprising (i) an outer portion, (ii) a sealing portion, and (iii) an attaching portion between the outer portion and the sealing portion;
wherein the attaching portion comprises (i) a first layer including thermally-reactive adhesive material and (ii) a second layer including ferromagnetic material;
wherein the sealing portion comprises an adhesive layer;
positioning the patch assembly at the damaged portion so that the adhesive layer of the sealing portion engages the object at and around the damaged portion and forms a seal between the patch assembly and the object;
with the patch assembly positioned at the damaged portion, applying pressure at the patch assembly, and applying heat at the attaching portion;
wherein, with the patch assembly positioned at the damaged portion, applying pressure at the patch assembly causes the outer portion and the attaching portion of the patch assembly to flex and conform to a shape of the object;
wherein applying heat at the attaching portion comprises generating an electromagnetic field at the attaching portion, and wherein the ferromagnetic material of the second layer heats in response to the electromagnetic field;
wherein, with the patch assembly positioned at the damaged portion, applying heat at the attaching portion causes the thermally-reactive adhesive material of the first layer to at least partially melt; and
wherein, with the patch assembly positioned at the damaged portion, and with the attaching portion of the patch assembly flexed to conform to the shape of the object, and with the thermally-reactive adhesive material of the first layer at least partially melted, at least a portion of the thermally-reactive adhesive material of the first layer engages the object outboard of the sealing portion, and wherein the thermally-reactive adhesive material of the first layer cures to bond the patch assembly to the object.

2. The method of claim 1, further comprising, after the thermally-reactive adhesive material cures to bond the patch assembly to the object, applying heat at the attaching portion to cause the thermally-reactive adhesive material of the first layer to at least partially melt and release the bond between the patch assembly and the object.

3. The method of claim 1, wherein the patch assembly is positioned at the damaged portion of the object as a singular unit.

4. The method of claim 1, wherein the outer portion, the sealing portion and the attaching portion of the patch assembly are separately positioned at the damaged portion of the object.

5. The method of claim 1, wherein the outer portion of the patch assembly comprises a plurality of layers of thermoplastic composite material, and wherein the plurality of layers are stacked relative to one another in a tapered orientation.

6. The method of claim 1, wherein applying pressure at the patch assembly comprises applying a vacuum at the object and the patch assembly.

7. The method of claim 1, wherein applying pressure at the patch assembly comprises operating a resistance heating element to heat the patch assembly while applying pressure at the patch assembly.

8. The method of claim 7, wherein applying pressure at the patch assembly and operating the resistance heating element is before applying heat at the attaching portion.

9. The method of claim 1, further comprising, with the patch assembly positioned at the damaged portion of the object, positioning a heating blanket at the object and over the patch assembly, and wherein applying pressure at the patch assembly comprises forming a seal between the heating blanket and the object and forming a vacuum between the heating blanket and the object, and wherein generating the electromagnetic field comprises operating an induction element of the heating blanket.

10. The method of claim 9, wherein applying pressure at the patch assembly comprises operating a resistance heating element of the heating blanket to heat the patch assembly while applying pressure at the patch assembly.

11. The method of claim 1, wherein the object comprises one selected from the group consisting of (i) an airplane, (ii) a helicopter, (iii) a drone, (iv) a motor vehicle, (v) a railed vehicle, (vi) an amphibious vehicle, (vii) a boat, (viii) a building and (iv) a tool.

12. A patch system, the patch system comprising:
a first layer of a patch comprising a composite material, wherein the first layer comprises an exterior portion of the patch;
a second layer of the patch comprising a thermoplastic adhesive and a ferromagnetic material, wherein, when a body is being repaired by the patch system, the second layer is placed between the composite material of the first layer and the body;
wherein the ferromagnetic material of the second layer heats when exposed to an electromagnetic field;
an induction heating coil that is operable, when the body is being repaired by the patch system, to generate the electromagnetic field at the patch to cause the ferromagnetic material of the second layer to heat the thermoplastic adhesive of the second layer; and
wherein, when the body is being repaired by the patch system, and responsive to the induction heating coil operating to heat the thermoplastic adhesive of the second layer, the thermoplastic adhesive of the second layer at least partially melts between the first layer of the patch and the body and the thermoplastic adhesive of the second layer cures to bond the patch to the body.

13. The patch system of claim 12, wherein the thermoplastic adhesive is imbedded into the ferromagnetic material of the second layer.

14. The patch system of claim 12, wherein the ferromagnetic material comprises one selected from the group consisting of (i) a foil, (ii) a sheet, (iii) a mesh and (iv) a powder.

15. The patch system of claim 12, wherein the ferromagnetic material has a Curie temperature between 100 degrees Fahrenheit and 900 degrees Fahrenheit.

16. The patch system of claim 12, wherein the ferromagnetic material is separate and distinct from the thermoplastic adhesive.

17. The patch system of claim 12, wherein the patch comprises a rounded shape.

18. The patch system of claim 12, wherein a third layer of the patch comprises a sealing tape, and wherein the sealing tape is disposed between the second layer of the patch and the body when the body is being repaired by the patch system.

19. The patch system of claim 18, wherein the first layer, the second layer, and the third layer of the patch are applied to the body as a unit when the body is being repaired by the patch system.

20. The patch system of claim 18, wherein the first layer, the second layer, and the third layer of the patch are applied to the body separately from one another when the body is being repaired by the patch system.

21. The patch system of claim 18, wherein the sealing tape comprises one selected from the group consisting of (i) a metalized tape, (ii) a reinforced composite tape and (iii) a self-sealing tape.

22. The patch system of claim 12, wherein the thermoplastic adhesive of the second layer comprises one selected from the group consisting of (i) a thermoplastic, (ii) a thermoset and (iii) a combination of thermoplastic and thermoset.

23. The patch system of claim 12, wherein the composite material of the first layer has a melting temperature between 100 degrees Fahrenheit and 900 degrees Fahrenheit.

24. The patch system of claim 12, wherein the composite material of the first layer comprises one or more plies.

25. The patch system of claim 12, wherein the composite material of the first layer comprises a woven intermingled fiber composite.

26. The patch system of claim 12, wherein the induction heating coil is accommodated by a vacuum membrane.

27. The patch system of claim 26, wherein the vacuum membrane accommodates a plurality of induction heating coils, and wherein at least one induction heating coil of the plurality of induction heating coils is operable to heat a heating wire accommodated by the vacuum membrane, and wherein another induction heating coil of the plurality of induction heating coils is operable to generate the electromagnetic field at the patch to heat the ferromagnetic material of the second layer.

28. The patch system of claim 26, wherein the vacuum membrane comprises a film, and wherein, when the body is being repaired by the patch system, the film is sealed to the body with one selected from the group consisting of (i) a tape and (ii) a putty, and wherein the at least one induction coil is between the film and the body when the body is being repaired by the patch system.

29. The patch system of claim 26, wherein, when the body is being repaired by the patch system, the induction heating coil operates at more than one frequency.

30. A method for repairing a damaged portion of an object, the method comprising:
with a plug disposed at an attachment surface of the object at or near the damaged portion of the object, applying pressure to urge the plug toward engagement with the attachment surface of the object;
wherein the attachment surface of the object comprises a composite material, and wherein the plug comprises the composite material;
with the plug disposed at the attachment surface of the object, and with the plug urged toward engagement with the attachment surface of the object, energizing a ferromagnetic heating element to heat the plug and the attachment surface of the object; and
wherein heating the plug and the attachment surface of the object causes the composite material of the plug to at least partially melt, and wherein the composite material cures to bond the plug to the object.

31. The method of claim 30, wherein the plug and the attachment surface of the object comprise one selected from the group consisting of (i) a thermoplastic composite material and (ii) a thermoset composite material.

32. The method of claim 30, further comprising removing a portion of the composite material of the object at or near the damaged portion to form the attachment surface.

33. The method of claim 30, wherein the ferromagnetic heating element is disposed between the plug and the attachment surface of the object.

34. The method of claim 33, wherein the ferromagnetic heating element comprises a ferromagnetic material and a resin material, and wherein energizing the ferromagnetic heating element causes the ferromagnetic material to heat and causes the resin material to at least partially melt, and wherein the composite material of the plug and the resin material of the ferromagnetic heating element cure to bond the plug to the object.

35. The method of claim 30, wherein applying pressure comprises applying a clamping pressure between the plug and the object.

36. The method of claim 30, wherein applying pressure comprises applying a vacuum source to the plug and the object.

37. The method of claim 36, wherein the vacuum source comprises a heating blanket disposed at the object and extending over the damaged portion of the object and the plug.

38. The method of claim 37, wherein the heating blanket comprises an induction element, and wherein energizing the ferromagnetic heating element comprises operating the induction element to generate a magnetic field at the ferromagnetic heating element such that ferromagnetic material of the ferromagnetic heating elements heats in response to the magnetic field.

39. The method of claim 30, wherein the plug is disposed between the ferromagnetic heating element and the attachment surface of the object.

40. The method of claim 30, wherein the ferromagnetic heating element comprises an induction field source and ferromagnetic material, and wherein energizing the ferromagnetic heating element comprises operating the induction field source to generate a magnetic field at the ferromagnetic material such that the ferromagnetic material heats in response to the magnetic field.

41. The method of claim 40, wherein the induction field source comprises a flexible coil.

42. The method of claim 40, wherein the induction field source comprises a rigid coil.

43. The method of claim 40, wherein applying pressure comprises engaging a coil of the induction field source at the plug.

44. The method of claim 40, wherein the induction field source comprises a coil positioned at or near the damaged portion of the object using at least one selected from the group consisting of (i) a suction cup, (ii) a magnetic fastener, (iii) a temporary fastener, (iv) an adhesive and (v) a tape.

45. The method of claim 30, wherein applying pressure comprises engaging a spring at the plug, and wherein the spring comprises at least one selected from the group consisting of (i) a leaf spring and (ii) a disc spring.

46. The method of claim 30, wherein applying pressure comprises clamping the plug between the object and an external structure.

47. The method of claim 30, further comprising, with the plug bonded to the object, applying heat to the plug to at least partially melt the composite material of the plug and release the plug from the object.
